(19) United States
(12) Patent Application Publication
(10) Pub. No.: US 2024/0184866 A1
(43) Pub. Date: Jun. 6, 2024

(54) DATABASE MANAGING METHOD, HUMAN-FACE-AUTHENTICATION METHOD, DEVICE AND STORAGE MEDIUM

(71) Applicant: BOE Technology Group Co., Ltd., Beijing (CN)

(72) Inventors: Yang Zhang, Beijing (CN); Xiaoqin Guo, Beijing (CN); Han Li, Beijing (CN); Mingyuan Ma, Beijing (CN)

(73) Assignee: BOE Technology Group Co., Ltd., Beijing (CN)

(21) Appl. No.: 17/796,781

(22) PCT Filed: Sep. 23, 2021
(86) PCT No.: PCT/CN2021/119957

§ 371 Date: Aug. 1, 2022

(51) Int. Cl. G06F 21/32; G06V 40/16

(52) U.S. Cl. CPC G06F 21/32; G06V 40/172

(57) ABSTRACT

The present disclosure provides a database managing method, a human-face-authentication method, a device and a storage medium, which relates to the technical field of computers. The method is applied to a human-face-recognition platform, the human-face-recognition platform is connected to a central server of a head office, the central server is, via a branch-office server of a branch office of the head office, connected to outlet servers of outlets of the branch office, and the method includes: acquiring user data of an target user, selecting a target outlet matching with the user data from the outlets; and controlling the central server to dispatch a user feature of the target user to a target-outlet server of the target outlet via the branch-office server, so that the target-outlet server performs human-face recognition to the target user according to the user feature.

### TECHNICAL FIELD

The present disclosure relates to the technical field of computers, and more particularly, to a database managing method, a human-face-authentication method, a device and a storage medium.

### BACKGROUND

With the continuous reconstruction of smart bank outlets, intelligent terminals and camera devices have been accessed to the outlets, and various application scenes such as human-face detection, human-face recognition, action identification and client-flow analysis have been practically applied to the intelligent outlets. Each of the outlet has increasingly higher concurrent demands on the human-face authentication. If each of the outlets is provided with one AI-identification system separately, that results in resource waste. If one AI-identification system is provided collectively, the concurrency of the terminals of the outlets of the entire network results in a very high requirement on the calculation capacity of the central server, and the responses are delayed.

### SUMMARY

The present disclosure provides a database managing method, a human-face-authentication method, a device and a storage medium.

Some embodiments of the present disclosure provide a database managing method, wherein the method is applied to a human-face-recognition platform, the human-face-recognition platform is connected to a central server of a head office, the central server is, via a branch-office server of a branch office of the head office, connected to outlet servers of outlets of the branch office, and the method includes:
acquiring user data of a target user;
selecting a target outlet matching with the user data from the outlets; and
controlling the central server to dispatch a user feature of the target user to a target-outlet server of the target outlet via the branch-office server, to make the target-outlet server perform human-face recognition to the target user according to the user feature.

Optionally, the user data include: a user permanent location; and
the step of selecting the target outlet matching with the user data from the outlets includes:
calculating location distances between outlet locations of the outlets and the user permanent location; and
using an outlet whose location distance satisfies a service-distance requirement as the target outlet.

Optionally, the step of using the outlet whose location distance satisfies the service-distance requirement as the target outlet includes:
if the user permanent location includes a residential location, using at least three outlets that have lowest location distances from the residential location as the target outlet.

Optionally, the step of using the outlet whose location distance satisfies the service-distance requirement as the target outlet includes:
if the user permanent location includes a residential location and a activity location, using at least one outlet that has a lowest location distance from the residential location and at least two outlets that have lowest location distances from the activity location as the target outlet.

Optionally, the step of calculating the location distances between the outlet locations of the outlets and the user permanent location includes:
calculating vector comparison values between the user permanent location and the outlet locations, wherein the outlet locations are vectors formed by a province, a city, a county, a town, a street and a community; and
using an outlet whose vector comparison value is greater than a comparison-value threshold as the target outlet.

Optionally, the step of using the outlet whose vector comparison value is greater than the comparison-value threshold as the target outlet includes:
using outlets whose vector comparison values are greater than the comparison-value threshold as candidate outlets:
if a quantity of the candidate outlets is less than or equal to a quantity threshold, using the candidate outlets as the target outlet; and
if the quantity of the candidate outlets is greater than the quantity threshold, using a target quantity of the candidate outlets that have lowest location distances from the user permanent location as the target outlet.

Optionally, the user data include: a user service type; and
the step of selecting the target outlet matching with the user data from the outlets includes:
using an outlet, among the outlets, whose scope of services includes the user service type as the target outlet.

Some embodiments of the present disclosure provide a human-face-authentication method, wherein the method is applied to an outlet server of an outlet, the outlet server acquires a user feature by using the database managing method stated above, and the method includes:
receiving a human-face-authentication request carrying a human-face image;
if a user feature matching with the human-face image is not obtained by inquiring in a local outlet database, sending the human-face-authentication request to the branch-office server of the branch office; and
receiving a human-face-authentication result sent by the branch-office server according to the human-face-authentication request, and synchronizing the user feature from the branch-office server.

Optionally, the method further includes:
according to a preset time period, counting up usage frequency of user features; and
deleting, from the local outlet database, a user feature whose usage frequency is less than a frequency threshold.

An embodiment of the present disclosure provides a human-face-authentication method, wherein the method is applied to a branch-office server of a branch office, the branch-office server acquires a user feature by using the database managing method stated above, and the method includes:
receiving a human-face-authentication request carrying a human-face image sent by an outlet server of an outlet:
if a user feature matching with the human-face image is not obtained by inquiring in a local branch-office database, sending the human-face-authentication request to the central server of the head office:
receiving a human-face-authentication result sent by the central server according to the human-face-authentication request, and forwarding the human-face-authentication result to the outlet server; and
synchronizing the user feature from the central server, and synchronizing the user feature to the outlet server.

Optionally, the branch-office database includes: a high-frequency database and a low-frequency database; and
before the step of, if a user feature matching with the human-face image is not obtained by inquiring in the local outlet database, sending the human-face-authentication request to the branch-office server of the branch office, the method further includes:
if the user feature matching with the human-face image is not obtained by inquiring in the high-frequency database, inquiring the user feature matching with the human-face image in the low-frequency database.

Optionally, the method further includes:
if a data volume of the low-frequency database is greater than a data volume of the high-frequency database, deleting user features of a preset data-volume proportion in the low-frequency database that have lowest usage frequency; and
if the data volume of the low-frequency database is less than the data volume of the high-frequency database, deleting a user feature in the low-frequency database that has a usage frequency less than a usage-frequency threshold.

Some embodiments of the present disclosure provide a database managing apparatus, wherein the apparatus is applied to a human-face-recognition platform, the human-face-recognition platform is connected to a central server of a head office, the central server is, via a branch-office server of a branch office of the head office, connected to outlet servers of outlets of the branch office, and the apparatus includes:
a first receiving module configured for acquiring user data of an target user:
a first processing module configured for selecting a target outlet matching with the user data from the outlets; and
a first synchronizing module configured for controlling the central server to dispatch a user feature of the target user to a target-outlet server of the target outlet via the branch-office server, so that the target-outlet server performs human-face recognition to the target user according to the user feature.

Optionally, the user data include: a user permanent location; and
the first processing module is further configured for:
calculating location distances between outlet locations of the outlets and the user permanent location; and
using an outlet whose location distance satisfies a service-distance requirement as the target outlet.

Optionally, the first processing module is further configured for:
if the user permanent location includes a residential location, using at least three outlets that have lowest location distances from the residential location as the target outlet.

Optionally, the first processing module is further configured for:
if the user permanent location includes a residential location and a activity location, using at least one outlet that has a lowest location distance from the residential location and at least two outlets that have lowest location distances from the activity location as the target outlet.

Optionally, the first processing module is further configured for:
calculating vector comparison values between the user permanent location and the outlet locations, wherein the outlet locations are vectors formed by a province, a city, a county, a town, a street and a community; and
using an outlet whose vector comparison value is greater than a comparison-value threshold as the target outlet.

Optionally, the first processing module is further configured for:
using outlets whose vector comparison values are greater than the comparison-value threshold as candidate outlets:
if a quantity of the candidate outlets is less than or equal to a quantity threshold, using the candidate outlets as the target outlet; and
if the quantity of the candidate outlets is greater than the quantity threshold, using a target quantity of the candidate outlets that have lowest location distances from the user permanent location as the target outlet.

Optionally, the user data include: a user service type; and
the first processing module is further configured for:
using an outlet, among the outlets, whose scope of services includes the user service type as the target outlet.

Some embodiments of the present disclosure provide a human-face-authentication apparatus, wherein the apparatus is applied to an outlet server of an outlet, the outlet server acquires a user feature by using the database managing apparatus stated above, and the apparatus includes:
a second receiving module configured for receiving a human-face-authentication request carrying a human-face image:
a second processing module configured for, if a user feature matching with the human-face image is not obtained by inquiring in a local outlet database, sending the human-face-authentication request to the branch-office server of the branch office; and
a second synchronizing module configured for receiving a human-face-authentication result sent by the branch-office server according to the human-face-authentication request, and synchronizing the user feature from the branch-office server.

Optionally, the apparatus further includes: a first updating module configured for:
according to a preset time period, counting up usage frequency of user features; and
deleting, from the local outlet database, a user feature whose usage frequency is less than a frequency threshold.

An embodiment of the present disclosure provides a human-face-authentication apparatus, wherein the apparatus is applied to a branch-office server of a branch office, the branch-office server acquires a user feature by using the database managing apparatus stated above, and the apparatus includes:
a third receiving module configured for receiving a human-face-authentication request carrying a human-face image sent by an outlet server of an outlet;
a third processing module configured for, if a user feature matching with the human-face image is not obtained by inquiring in a local branch-office database, sending the human-face-authentication request to the central server of the head office; and
receiving a human-face-authentication result sent by the central server according to the human-face-authentication request, and forwarding the human-face-authentication result to the outlet server; and
a third synchronizing module configured for synchronizing the user feature from the central server, and synchronizing the user feature to the outlet server.

Optionally, the branch-office database includes: a high-frequency database and a low-frequency database; and
the third processing module is further configured for:
if the user feature matching with the human-face image is not obtained by inquiring in the high-frequency database, inquiring the user feature matching with the human-face image in the low-frequency database.

Optionally, the apparatus further includes: a second updating module configured for:
if a data volume of the low-frequency database is greater than a data volume of the high-frequency database, deleting user features of a preset data-volume proportion in the low-frequency database that have lowest usage frequency; and
if the data volume of the low-frequency database is less than the data volume of the high-frequency database, deleting a user feature in the low-frequency database that has a usage frequency less than a usage-frequency threshold.

Some embodiments of the present disclosure provide a calculating and processing device, wherein the calculating and processing device includes:
a memory storing a computer-readable code; and
one or more processors, wherein when the computer-readable code is executed by the one or more processors, the calculating and processing device implements the database managing method or the human-face-authentication method stated above.

Some embodiments of the present disclosure provide a computer program, wherein the computer program includes a computer-readable code, and when the computer-readable code is executed in a calculating and processing device, the computer-readable code causes the calculating and processing device to implement the database managing method or the human-face-authentication method stated above.

Some embodiments of the present disclosure provide a non-transient computer-readable medium, wherein the non-transient computer-readable medium stores the database managing method or the human-face-authentication method stated above.

The above description is merely a summary of the technical solutions of the present disclosure. In order to more clearly know the elements of the present disclosure to enable the implementation according to the contents of the description, and in order to make the above and other purposes, features and advantages of the present disclosure more apparent and understandable, the particular embodiments of the present disclosure are provided below.

### BRIEF DESCRIPTION OF THE DRAWINGS

In order to more clearly illustrate the technical solutions of the embodiments of the present disclosure or the prior art, the figures that are required to describe the embodiments or the prior art will be briefly introduced below. Apparently, the figures that are described below are embodiments of the present disclosure, and a person skilled in the art may obtain other figures according to these figures without paying creative work.

FIG. 1 schematically shows a schematic flow chart of a database managing method according to some embodiments of the present disclosure:

FIG. 2 schematically shows a schematic diagram of the architecture of a human-face-authentication system according to some embodiments of the present disclosure;

FIG. 3 schematically shows a first schematic flow chart of another database managing method according to some embodiments of the present disclosure;

FIG. 4 schematically shows a second schematic flow chart of another database managing method according to some embodiments of the present disclosure;

FIG. 5 schematically shows a schematic diagram of the principle of a service-type dictionary according to some embodiments of the present disclosure;

FIG. 6 schematically shows a schematic logic diagram of another database managing method according to some embodiments of the present disclosure;

FIG. 7 schematically shows a first schematic flow chart of a human-face-authentication method according to some embodiments of the present disclosure;

FIG. 8 schematically shows a second schematic flow chart of a human-face-authentication method according to some embodiments of the present disclosure;

FIG. 9 schematically shows a first schematic flow chart of another human-face-authentication method according to some embodiments of the present disclosure;

FIG. 10 schematically shows a second schematic flow chart of another human-face-authentication method according to some embodiments of the present disclosure;

FIG. 11 schematically shows a schematic structural diagram of a database managing apparatus according to some embodiments of the present disclosure:

FIG. 12 schematically shows a schematic structural diagram of a human-face-authentication apparatus according to some embodiments of the present disclosure.

FIG. 13 schematically shows a schematic structural diagram of another human-face-authentication apparatus according to some embodiments of the present disclosure;

FIG. 14 schematically shows a block diagram of a calculating and processing device for implementing the method according to some embodiments of the present disclosure; and

FIG. 15 schematically shows a storage unit for maintaining or carrying a program code for implementing the method according to some embodiments of the present disclosure.

### DETAILED DESCRIPTION OF THE EMBODIMENTS

In order to make the objects, the technical solutions and the advantages of the embodiments of the present disclosure clearer, the technical solutions of the embodiments of the present disclosure will be clearly and completely described below with reference to the drawings of the embodiments of the present disclosure. Apparently, the described embodiments are merely certain embodiments of the present disclosure, rather than all of the embodiments. All of the other embodiments that a person skilled in the art obtains on the basis of the embodiments of the present disclosure without paying creative work fall within the protection scope of the present disclosure.

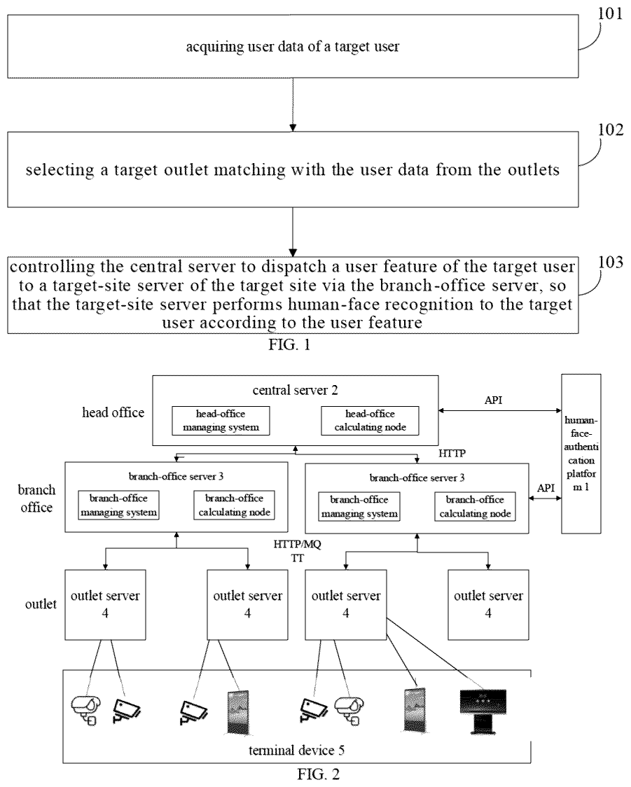

FIG. 1 schematically shows a schematic flow chart of a database managing method according to the present disclosure. The method is applied to a human-face-recognition platform, the human-face-recognition platform is connected to a central server of a head office, the central server is connected to outlet servers of outlets of the branch office via a branch-office server of a branch office of the head office, and the method includes:

It should be noted that the head office, the branch office and the outlets are sequentially of a subordination relation. In other words, the head office has multiple branch offices, and a branch office has multiple outlets. For example, in a bank scene, the head office of the bank may establish bank branches in different cities, and the bank branches of the different cities may establish bank outlets at different locations of the cities. Alternatively, in a logistic scene, the head office may be the logistic center of a province, the branch offices may be the logistic transfer stations in the cities of the province subordinate to the logistic center, and the outlets may be the delivering points communicating with the logistic transfer stations. Alternatively, in an electric-power scene, the head office may be the parent power supply company of a province, the branch offices may be the branch power supply companies in the cities of the province, and the outlets are the power supply stations subordinate to the branch power supply companies. Certainly, the above are merely exemplary descriptions, which may be particularly configured according to practical demands, and is not limited herein.

Referring to FIG. 2, FIG. 2 shows a schematic structural diagram of a human-face-authentication system according to an embodiment of the present disclosure. The embodiment of the present disclosure employs a three-layer server architecture, wherein based on the management on the servers by a human-face-authentication platform 1, the central server 2 of the head office, the branch-office server 3 of the branch office and the outlet servers 4 of the outlets are individually provided with a server for human-face authentication, and all of the servers are provided with a database for storing user features, whereby all of the servers may perform human-face authentication to users by using the user features in the local database. The human-face-authentication platform 1 performs data transmission with the central server 2 of the head office and the branch-office server 3 of the branch office by means of an Application Programming Interface (API). The central server 2 performs data transmission with a branch-office reader 3 by means of a HyperText Transfer Protocol (HTTP), and the branch-office server 3 performs data transmission with the outlet servers by means of an HTTP protocol or a Message Queuing Telemetry Transport (MQTT) protocol.

Particularly, the human-face-authentication platform 1 is an application platform providing the service of human-face authentication. Particularly, it may provide an application program and a background-data support for human-face authentication to the servers, and may coordinate the data synchronization between the servers of different hierarchies, and manage the data updating of the databases in the servers.

The central server 2 of the head office contains a head-office managing system, which is configured for storing and managing the user features of all of the branch offices, and displaying them by means of data visualization for the users to inquire. The central server 2 further contains a head-office calculating node, which may process and transmit a data volume of the grade of ten million, and has the characteristics of a large and complete data volume and a low execution efficiency.

The branch-office server 3 of the branch office contains a branch-office managing system, which is configured for storing and managing the user features of all of the outlets subordinate to the branch office, and displaying them by means of data visualization for the users to inquire, to manage the devices and the algorithm models of the outlets. The branch-office server 3 further contains a branch-office data node, which may process and transmit a data volume of the grade of millions, and has the characteristics that the branch-office data node is in the middle of the three hierarches, its execution efficiency is higher than that of the head-office calculating node, but the execution efficiency is lower than the outlet calculating node.

The outlet server 4 of the outlet contains an outlet calculating node, which may process and transmit a data volume of the grade of hundred thousand, and the outlet server 4 may be communicatively connected to various image shooting terminals 5 with the function of image acquisition, thereby acquiring the human-face images of the users by uploading methods such as a network or a USB (Universal Serial Bus).

It should be noted that all of the central server 2, the branch-office server 3 and the outlet servers 4 according to the embodiments of the present disclosure have the function of human-face authentication, and may perform human-face authentication to the human-face images of the users by using the user features in the local database or a remote database.

Step 101: acquiring user data of a target user.

In an embodiment of the present disclosure, the target user is a user that requires human-face authentication. A user is required to register on the human-face-authentication platform by uploading his own user data when performing human-face authentication for the first time. The user data may be a user feature for performing human-face authentication, and may also be the data such as the domicile, the job, the hobby, the service demand, and so on, of the user, which may be particularly configured according to practical demands, and is not limited herein.

In practical applications, after the user performs the collection of the user feature and fills in various user data by using a terminal device installed with the human-face-authentication application, such as a mobile phone and a computer, or a service equipment such as a bastion host, the user data are integrated into a registration request and uploaded to the outlet server, the outlet server forwards the registration request carrying the user data to the branch-office server, and the branch-office server directly sends the registration request to the human-face-authentication platform or forwards the registration request to the human-face-authentication platform via the central server.

Step 102: selecting a target outlet matching with the user data from the outlets.

In an embodiment of the present disclosure, the human-face-authentication platform, after completing the registration of the target user according to the user data in the registration request, based on the user data, screening out a target outlet that the user may visit based on the user data. As an example, an outlet within the activity area of the user or at the periphery of the activity area of the user may be screened out as the target outlet, wherein because of the target outlet is within or at the periphery of the activity area of the user, the user is more likely to visit these target outlets for business. It may also screen out the outlets which may undertake the service of the user as the target outlets, the user is more likely to visit these target outlets because only these target outlets are capable to undertake the service required by the user. Optionally, the location that the user may visit in future is predicted based on the user data by using a behavior-prediction model, or the service type that the user may take in future is predicted, whereby an outlet at the periphery of the location obtained by the prediction or an outlet that may undertake the predicted service type may be used as the target outlet, thereby pre-screening out the outlet with a high possibility which the user may visit. Certainly, the above are merely exemplary descriptions, it is merely required to screen out the outlet with a high possibility which the user may visit, and the screening mode is not limited herein.

Step 103: controlling the central server to dispatch a user feature of the target user to a target-outlet server of the target outlet via the branch-office server, so that the target-outlet server performs human-face recognition to the target user according to the user feature.

It should be noted that the user feature refers to the characteristic information configured for being compared with the human-face image uploaded by the user to realize the human-face authentication, and may be obtained in advance by performing feature collection to a standard human-face image provided by the user.

In an embodiment of the present disclosure, the human-face-authentication platform sends an instruction to the central server after determining the target outlet with a high probability of user visiting, whereby the central server synchronizes the user feature of the target user to the outlet database of the branch-office server of the branch office that the target outlet is subordinate to, whereby the branch-office server subsequently synchronizes the user feature to the outlet database of the target outlet. Therefore, when the target user visits the target outlet to take a service and requires human-face authentication, the outlet server of target outlet may inquire the user feature of the target user in the local outlet database, and complete the human-face authentication locally by comparing the human-face image currently provided by the user and the user feature. Therefore, it is not required to send the human-face image to the branch-office server or the central server for the authentication in every time of human-face authentication, which does not only alleviate the pressure of data processing of the branch-office server and the central server, but also reduces the problem of slow acquirement of the authentication result caused by the data transmission delay, thereby increasing the efficiency of the human-face authentication.

In the embodiments of the present disclosure, the target outlets that the user may visit are screened out from the outlets according to the user data, and accordingly the user feature is dispatched to those target outlets, whereby the outlet servers of the target outlets may perform the human-face authentication to the target user based on the user feature in the local databases, which does not only alleviate the pressure of data processing of the branch-office server and the central server, but also increases the efficiency of the human-face authentication.

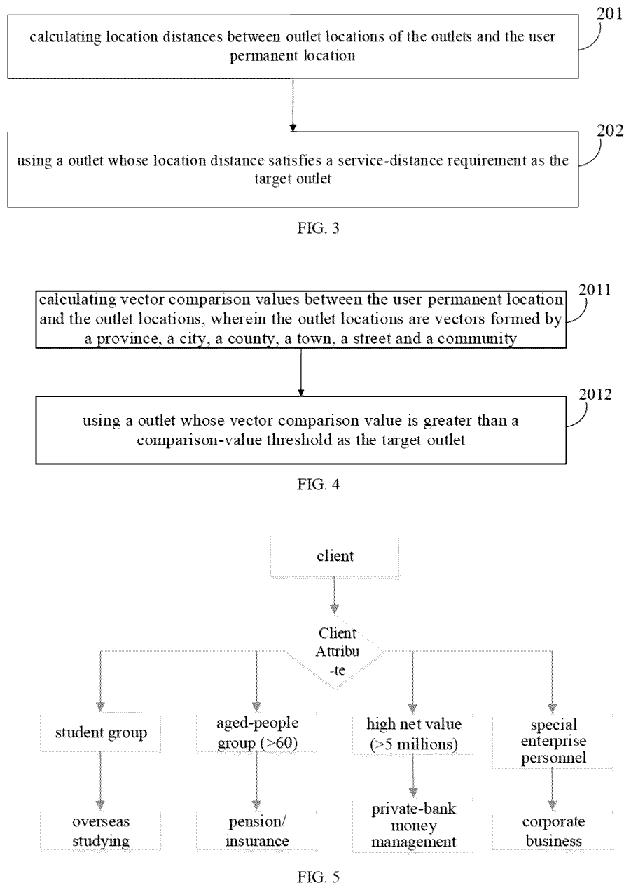

Optionally, the user data include: a user permanent location. Referring to FIG. 3, the step 102 may include:

Step 201: calculating location distances between outlet locations of the outlets and the user permanent location.

It should be noted that the user permanent location refers to the geographic location that has a high probability which the user appears there in daily life. A position with a probability which the user appears there greater than a preset probability may be used as the user permanent location, and a residential location, a working location and other desired locations that the user inputs himself may also be used, which may be particularly configured according to practical demands, and is not limited herein. The outlet location refers to information that may reflect the geographic location where an outlet is located.

In an embodiment of the present disclosure, the straight-line distance between two points may be calculated according to the longitudes and the latitudes of the user permanent location and the outlet location by solving the diagonal-line distance by using trigonometric function. Certainly, the path line between the user permanent location and the outlet location may be calculated by using road information as the location distance. That may be particularly configured according to practical demands, and is not limited herein.

Step 202: using an outlet whose location distance satisfies a service-distance requirement as the target outlet.

In an embodiment of the present disclosure, the user usually visits the outlet close to himself to take the service, so that if an outlet has a lower location distance, it has a higher probability to be vioutletd by the user. However, considering that the user also moves at the periphery of his permanent location, the outlets whose location distances rank the first 3 or the first 5 may be used as the target outlets with high probabilities to be vioutletd by the user, so that the determined target outlets are more accurate, which improves the accuracy of the subsequent dispatching of the user feature.

Optionally, the step 202 may include: if the user permanent location includes a residential location, using at least three outlets with lowest location distances from the residential location as the target outlet.

In an embodiment of the present disclosure, if the user permanent location merely includes the residential location, then, in order to ensure that all of the outlets at the periphery of the residential location of the user may store the user feature of the user, in the outlet screening, at least three outlets with the lowest location distances from the residential location of the user may be screened out as the target outlets, so that all of the outlets within the area of the periphery of the residential location of the user store his user feature, which improves the accuracy of the subsequent dispatching of the user feature.

Optionally, the step 202 may include: if the user permanent location includes a residential location and a activity location, using at least one outlet with a lowest location distance from the residential location and at least two outlets with lowest location distances from the activity location as the target outlet.

It should be noted that the activity location refers to an address location where the user is frequently located in everyday life other than the residential location of the user, for example, a working location, an entertainment location, and so on, of the user, which may be particularly configured according to practical demands, and is not limited herein.

In an embodiment of the present disclosure, if the user permanent location includes both of the residential location and the activity location, considering that the probability which the client takes a service at a weekend is obviously greater than the probability of a working time or other times, at least two target outlets are selected at the periphery of the residential location, and at least one outlet is selected at the periphery of each of the activity locations, which may better cover the characteristics of the activity space of the client.

Optionally, referring to FIG. 4, the step 201 may include:

Step 2011: calculating vector comparison values between the user permanent location and the outlet locations, wherein the outlet locations are vectors formed by a province, a city, a county, a town, a street and a community.

In an embodiment of the present disclosure, the outlet location of the outlet and the user permanent location are configured to be in the form of vectors having multiple dimensions such as a province, a city, a county, a town, a street, a community and a periphery, so that a vector comparison value between the outlet location and the user permanent location may be calculated, which may reflect the location distance between the user permanent location and the outlet location.

Step 2012: using an outlet whose vector comparison value is greater than a comparison-value threshold as the target outlet.

In an embodiment of the present disclosure, a higher vector comparison value indicates a lower distance between the outlet and the user permanent location. Therefore, by presetting a comparison-value threshold, the target outlet whose vector comparison value is greater than the comparison-value threshold may be screened.

Optionally, the step 2012 may include:
A1: using outlets whose vector comparison values are greater than the comparison-value threshold as candidate outlets:
A2: if a quantity of the candidate outlets is less than or equal to a quantity threshold, using the candidate outlets as the target outlet; and
A3: if the quantity of the candidate outlets is greater than the quantity threshold, using a target quantity of the candidate outlets with lowest location distances from the user permanent location as the target outlet.

In an embodiment of the present disclosure, it is taken into consideration that the distance calculation is performed within the area of a city; in other words, the distance between two outlets usually does not exceed 200 kilometers. Because of the small area, the longitude lines and the latitude lines may be considered as straight lines. Firstly, the distance A between two outlets in the south-north direction is solved, then the distance B in the east-west direction is solved, and finally the rectangular diagonal-line distance is solved, i.e., sqrt(A*A+B*B), which is used as the compared distance value. Such a comparing method, as compared with the mode of calculating the real curved-surface distance, combines the characteristics of the actual service and outlet distribution, which may satisfy the demands on the services, and may greatly increase the efficiency of calculation. Even if there is a very small error value, overall database-value optimization may be performed by using the mechanism of the subsequent optimization of the dynamic-feature database.

Optionally, the user data include: a user service type. The step 102 may include: using an outlet whose scope of services includes the user service type as the target outlet from the outlets.

In an embodiment of the present disclosure, the user service type refers to a user label that reflects the service with a high probability which the user takes it, and may be obtained by performing dictionary analysis to the client group that the user belongs to, the job type of the user, the historical service record of the user and so on. As an example, referring to FIG. 5, the dictionary may map the users belonging to the student group in the user data to the service type of overseas studying, may map the aged-people group of the age higher than sixty to the service type of pension/insurance, may map the users of a net deposit value greater than five million to the service type of private-bank money management, and may map the users belonging to special enterprise personnel to the service type of corporate business. Certainly, the above are merely exemplary descriptions, and the particular matching mechanism based on the service types may be configured according to practical demands, and is not limited herein.

Optionally, regarding the mechanism based on the residential location, the activity location and the service matching, the configuration of the quantity of the screened target outlets may refer to the following Table 1:

TABLE 1

| | residence-location | activity-location | service |
|---|---|---|---|
| | matching | matching | matching |
| outlet quantity | 1 | 1 | 1 |
| outlet quantity | 2 | 0 | 1 |
| outlet quantity | 2 | 1 | 0 |
| outlet quantity | 3 | 0 | 0 |

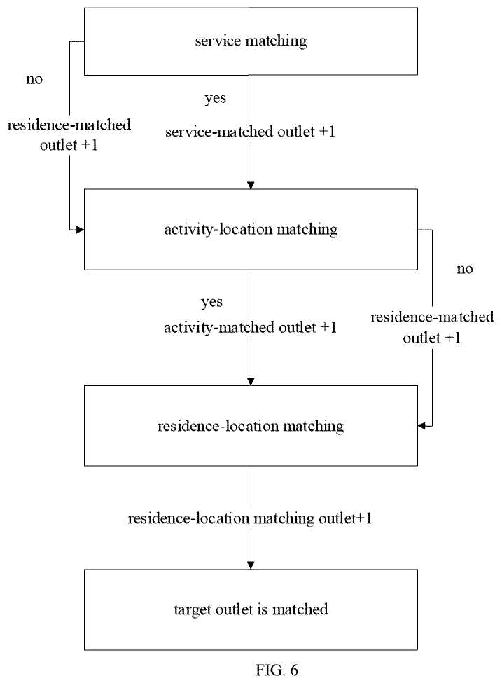

Referring to FIG. 6, the human-face-authentication platform firstly performs the service matching based on the user service type after acquiring the user data; if the matching succeeds, then adds 1 target outlet matching with the user service type, and enters the activity-location matching; if the matching fails, then directly enters the activity-location matching, and adds +1 to the quantity of the target outlet of the subsequent residence-location matching: if the activity-location matching succeeds, then adds 1 target outlet matching with the activity location; and if the activity-location matching fails, then adds +1 to the quantity of the target outlet of the subsequent residence-location matching. The quantity of the target outlet of the original residence-location matching is 1, and if it is added +1 in the stage of the service matching and added +1 in the stage of the activity-location matching, then the quantity of the target outlet based on the residence-location matching is 1+1+1=3. If it is added +0 in the stage of the service matching and added +1 in the stage of the activity-location matching, then the quantity of the target outlet based on the residence-location matching is 0+1+1=2. If it is added +1 in the stage of the service matching and added +0 in the stage of the activity-location matching, then the quantity of the target outlet based on the residence-location matching is 1+0+1=2. If it is added +0 in the stage of the service matching and added +0 in the stage of the activity-location matching, then the quantity of the target outlet based on the residence-location matching is 0+0+1=1. Accordingly, the quantity of the screened target outlets is always maintained to be 3.

In some embodiments of the present disclosure, the usage frequency of the user features in the data of the outlet databases are counted up and reported to the human-face-authentication platform. By using a Socket long connection, the actual distribution and usage amount of the user features are statistically analyzed. The office managerial staff may adjust the hardware configuration according to actual situations of the terminal devices. For example, terminal devices whose calculation amount frequently exceeds the bearable load are suitably added other devices, and the quantity of terminal devices with an insufficient calculated amount may be suitably reduced.

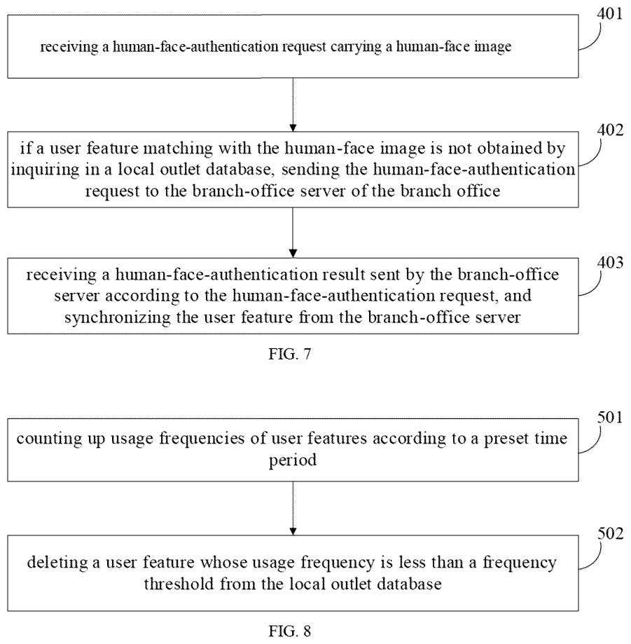

FIG. 7 schematically shows a human-face-authentication method according to the present disclosure. The method is applied to an outlet server of an outlet, the outlet server acquires a user feature by using the database managing method stated above, and the method includes:

Step 401: receiving a human-face-authentication request carrying a human-face image.

In an embodiment of the present disclosure, the user may photograph or upload/input the human-face image by using a terminal device installed with the client of the human-face-authentication application, thereby sending the human-face-authentication request carrying the human-face image to the outlet server.

Step 402: if a user feature matching with the human-face image is not obtained by inquiring in a local outlet database, sending the human-face-authentication request to the branch-office server of the branch office.

In an embodiment of the present disclosure, if the outlet server obtains the user feature matching with the human-face image by inquiring in the local outlet database, then it directly extracts the user feature from the outlet database, compares with the human-face image, and outputs the human-face-authentication result.

If the outlet server does not obtain the user feature matching with the human-face image by inquiring in the local outlet database, then the outlet server is required to forward the human-face-authentication request to the branch-office server of the branch office where the outlet is located for further authentication. The branch office further inquiries the user feature matching with the human-face image in its branch-office database, and if it is obtained by the inquiring, the branch-office server performs authentication to the human-face image. After the authentication is completed, the branch-office server returns the authentication result to the outlet server.

Step 403: receiving a human-face-authentication result sent by the branch-office server according to the human-face-authentication request, and synchronizing the user feature from the branch-office server.

In an embodiment of the present disclosure, the outlet server sends the authentication result to the terminal device, determines itself to be the target outlet with a high probability of user visiting, and synchronizes the user feature of the user from the branch-office server after receiving the authentication result returned by the branch-office server, it may be used for the human-face authentication when the user visits next time, and it is not required to request the branch-office server to perform the authentication again.

In the embodiments of the present disclosure, after the outlet server of the outlet performs the human-face authentication to the user for the first time, the user feature of the user is synchronized to the outlet server from the branch-office server, whereby the outlet server of the target outlet may perform the human-face authentication to the target user based on the user feature in the local database, which does not only alleviate the pressure of data processing of the branch-office server and the central server, but also increases the efficiency of the human-face authentication.

Optionally, referring to FIG. 8, the method further includes:

Step 501: counting up usage frequency of user features according to a preset time period.

Step 502: deleting a user feature whose usage frequency is less than a frequency threshold from the local outlet database.

In some embodiments of the present disclosure, this step may include, by using a preset time period, counting up the frequency of usages in human-face authentication of different user features according to a time dimension such as half a year or one year, sorting according to the priorities, determining a user feature whose usage frequency is less than the frequency threshold as not used for a long time, and accordingly deleting such a type of user features from the outlet database, which prevents the problem that, because of personnel transferring or other personal factors of the users, the outlet database stores useless user features for a long time, to result in redundancy of the outlet database.

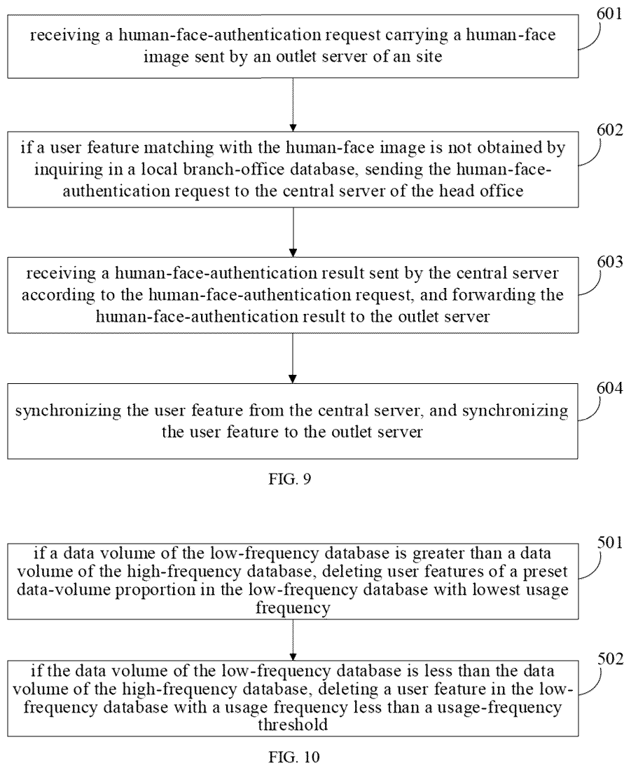

FIG. 9 schematically shows a human-face-authentication method according to the present disclosure. The method is applied to a branch-office server of a branch office, the branch-office server acquires a user feature by using the database managing method stated above, and the method includes:

Step 601: receiving a human-face-authentication request carrying a human-face image sent by an outlet server of an outlet.

In an embodiment of the present disclosure, if the outlet server of the outlet does not obtain the user feature matching with the human-face image in the human-face-authentication request by inquiring locally, the outlet server forwards the human-face-authentication request to the branch-office server of the branch office.

Step 602: if a user feature matching with the human-face image is not obtained by inquiring in a local branch-office database, sending the human-face-authentication request to the central server of the head office.

In an embodiment of the present disclosure, if the branch-office server obtains the user feature matching with the human-face image by inquiring in the local branch-office database, then it directly extracts the user feature from the outlet database, compares with the human-face image, and outputs the human-face-authentication result. If the branch-office server does not obtain the user feature matching with the human-face image by inquiring in the branch-office database, then the branch-office server forwards the human-face-authentication request to the central server of the head office for processing.

Step 603: receiving a human-face-authentication result sent by the central server according to the human-face-authentication request, and forwarding the human-face-authentication result to the outlet server.

In an embodiment of the present disclosure, because the central server stores the user features of all of the branch offices, after the central server obtains the user feature matching with the human-face image by inquiring in the database of the head office, the central server may compare the human-face image and the user feature, output the authentication result, and return the authentication result to the branch-office server. The branch-office server subsequently forwards the authentication result to the outlet server, to complete the human-face authentication.

Step 604: synchronizing the user feature from the central server, and synchronizing the user feature to the outlet server.

In an embodiment of the present disclosure, the branch-office server synchronizes the user feature from the central server, and synchronizes the user feature to the outlet server, whereby the branch-office server and the outlet server may complete the human-face authentication of the user locally when receiving the human-face-authentication request of the user next time.

In the embodiments of the present disclosure, after the branch-office server of the branch office performs the human-face authentication to the user for the first time, the user feature of the user is synchronized to the branch-office server from the server of the head office, and is subsequently synchronized to the outlet server by the branch-office server. Therefore, when the user performs human-face authentication at an outlet of the branch office next time, the human-face authentication may be performed to the target user based on the user feature in the local database, which does not only alleviate the pressure of data processing of the branch-office server and the central server, but also increases the efficiency of the human-face authentication.

Optionally, the branch-office database includes: a high-frequency database and a low-frequency database. Before the step 602, the method further includes: if the user feature matching with the human-face image is not obtained by inquiring in the high-frequency database, inquiring the user feature matching with the human-face image in the low-frequency database.

In an embodiment of the present disclosure, the method may include: calculating the average value of the usage frequency of all of the user features, grouping the user features whose usage frequency is greater than the average value into the high-frequency database, and grouping the user features whose usage frequency is less than the average value into the low-frequency database, to obtain the high-frequency database and the low-frequency database. Accordingly, in the inquiring of the user feature, the high-frequency database may be firstly inquired, and only if it cannot be obtained by inquiring in the high-frequency database, the low-frequency database is inquired, which may reduce the data volume inquired in the database, and increase the hit rate of the calculation of the user feature, thereby increasing the efficiency of the human-face authentication.

Optionally, referring to FIG. 10, the method further includes:

Step 701: if a data volume of the low-frequency database is greater than a data volume of the high-frequency database, deleting user features of a preset data-volume proportion in the low-frequency database with lowest usage frequency.

In an embodiment of the present disclosure, the data volumes of the low-frequency database and the high-frequency database are compared, and if the data volume of the low-frequency database is greater than the data volume of the high-frequency database, the user features of a preset data-volume proportion that is higher than part of the lowest-frequency data by, for example, 10% are removed from the low-frequency database. Here, other percentage values may also be set, for example, 5%, 20% and so on, and the parameter may also be adjusted according to the variation of the actual feature database. Such an adjustment mode has a high calculation speed, and the state of the removal of the user feature is gentle and stable. The amplitude of the optimization may be changed by adjusting the threshold.

Step 702: if the data volume of the low-frequency database is less than the data volume of the high-frequency database, deleting a user feature in the low-frequency database with a usage frequency less than a usage-frequency threshold.

In an embodiment of the present disclosure, if the data volume of the low-frequency database is less than the data volume of the high-frequency database for a long time, for example, by a preset duration such as one year or two years, wherein the preset duration may also be a preset default value, and usually the duration for which the branch-office database keeps the user feature should be greater than the duration of the keeping of the outlet database, then such a mechanism is triggered, and the user feature in the low-frequency database with a usage frequency less than the usage-frequency threshold is directly and forcibly deleted, whereby alleviating the pressure of the data storage of the branch-office database.

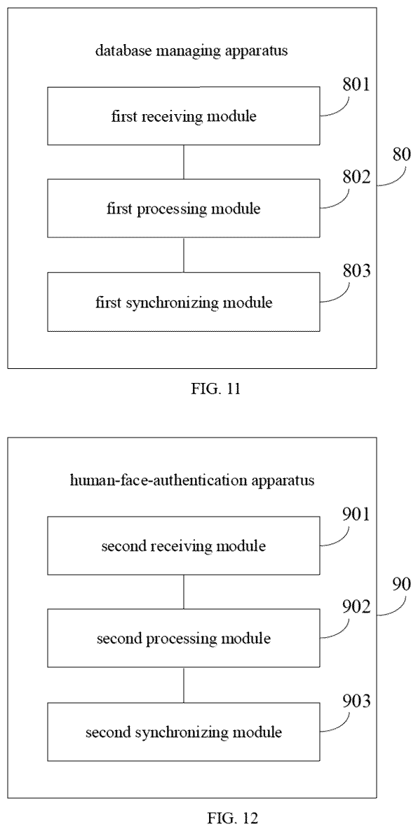

FIG. 11 schematically shows a schematic structural diagram of a database managing apparatus 80 according to the present disclosure. The apparatus is applied to a human-face-recognition platform, the human-face-recognition platform is connected to a central server of a head office, the central server is connected to outlet servers of outlets of the branch office via a branch-office server of a branch office of the head office, and the apparatus includes:
a first receiving module 801 configured for acquiring user data of a target user;
a first processing module 802 configured for selecting a target outlet matching with the user data from the outlets; and
a first synchronizing module 803 configured for controlling the central server to dispatch a user feature of the target user to a target-outlet server of the target outlet via the branch-office server, so that the target-outlet server performs human-face recognition to the target user according to the user feature.

Optionally, the user data include: a user permanent location; and
the first processing module 802 is further configured for:
calculating location distances between outlet locations of the outlets and the user permanent location; and
using an outlet whose location distance satisfies a service-distance requirement as the target outlet.

Optionally, the first processing module 802 is further configured for:
if the user permanent location includes a residential location, using at least three outlets with lowest location distances from the residential location as the target outlet.

Optionally, the first processing module 802 is further configured for:
if the user permanent location includes a residential location and a activity location, using at least one outlet with a lowest location distance from the residential location and at least two outlets with lowest location distances from the activity location as the target outlet.

Optionally, the first processing module 802 is further configured for:
calculating vector comparison values between the user permanent location and the outlet locations, wherein the outlet locations are vectors formed by a province, a city, a county, a town, a street and a community; and
using an outlet whose vector comparison value is greater than a comparison-value threshold as the target outlet.

Optionally, the first processing module 802 is further configured for:
using outlets whose vector comparison values are greater than the comparison-value threshold as candidate outlets:
if a quantity of the candidate outlets is less than or equal to a quantity threshold, using the candidate outlets as the target outlet; and
if the quantity of the candidate outlets is greater than the quantity threshold, using a target quantity of the candidate outlets with lowest location distances from the user permanent location as the target outlet.

Optionally, the user data include: a user service type; and
the first processing module 802 is further configured for:
using an outlet, among the outlets, whose scope of services includes the user service type as the target outlet.

In the embodiments of the present disclosure, according to the user data, the target outlets that the user may visit are screened from the outlets, and accordingly the user feature is dispatched to those target outlets, whereby the outlet server of the target outlet may perform the human-face authentication to the target user based on the user feature in the local database, which does not only alleviate the pressure of data processing of the branch-office server and the central server, but also increases the efficiency of the human-face authentication.

FIG. 12 schematically shows a schematic structural diagram of a human-face-authentication apparatus 90 according to the present disclosure. The apparatus is applied to an outlet server of an outlet, the outlet server acquires a user feature by using the database managing apparatus stated above, and the apparatus includes:
a second receiving module 901 configured for receiving a human-face-authentication request carrying a human-face image;
a second processing module 902 configured for, if a user feature matching with the human-face image is not obtained by inquiring in a local outlet database, sending the human-face-authentication request to the branch-office server of the branch office; and
a second synchronizing module 903 configured for receiving a human-face-authentication result sent by the branch-office server according to the human-face-authentication request, and synchronizing the user feature from the branch-office server.

Optionally, the apparatus further includes: a first updating module configured for:
counting up usage frequency of user features according to a preset time period; and
deleting, from the local outlet database, a user feature whose usage frequency is less than a frequency threshold.

In the embodiments of the present disclosure, after the outlet server of the outlet performs the human-face authentication to the user for the first time, the user feature of the user is synchronized to the outlet server from the branch-office server, whereby the outlet server of the target outlet may perform the human-face authentication to the target user based on the user feature in the local database, which does not only alleviate the pressure of data processing of the branch-office server and the central server, but also increases the efficiency of the human-face authentication.

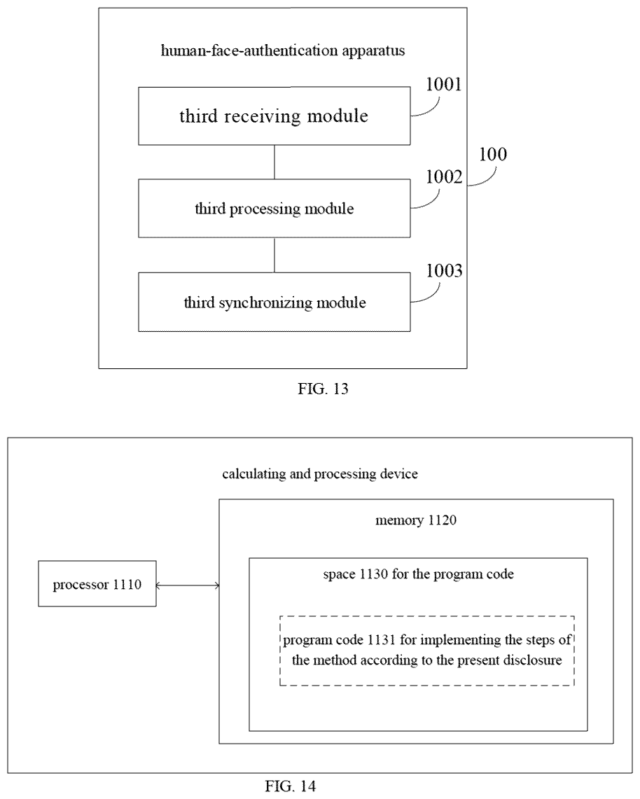

FIG. 13 schematically shows a schematic structural diagram of a human-face-authentication apparatus 100 according to the present disclosure. The apparatus is applied to a branch-office server of a branch office, the branch-office server acquires a user feature by using the database managing apparatus stated above, and the apparatus includes:
a third receiving module 1001 configured for receiving a human-face-authentication request carrying a human-face image sent by an outlet server of an outlet:
a third processing module 1002 configured for, if a user feature matching with the human-face image is not obtained by inquiring in a local branch-office database, sending the human-face-authentication request to the central server of the head office; and
receiving a human-face-authentication result sent by the central server according to the human-face-authentication request, and forwarding the human-face-authentication result to the outlet server; and
a third synchronizing module 1003 configured for synchronizing the user feature from the central server, and synchronizing the user feature to the outlet server.

Optionally, the branch-office database includes: a high-frequency database and a low-frequency database; and
the third processing module 1003 is further configured for:
if the user feature matching with the human-face image is not obtained by inquiring in the high-frequency database, inquiring the user feature matching with the human-face image in the low-frequency database.

Optionally, the apparatus further includes: a second updating module configured for:
if a data volume of the low-frequency database is greater than a data volume of the high-frequency database, deleting user features of a preset data-volume proportion in the low-frequency database with lowest usage frequency; and
if the data volume of the low-frequency database is less than the data volume of the high-frequency database, deleting a user feature in the low-frequency database with a usage frequency less than a usage-frequency threshold.

In the embodiments of the present disclosure, after the branch-office server of the branch office performs the human-face authentication to the user for the first time, the user feature of the user is synchronized to the branch-office server from the server of the head office, and is subsequently synchronized to the outlet server by the branch-office server. Therefore, when the user performs human-face authentication at an outlet of the branch office next time, the human-face authentication may be performed to the target user based on the user feature in the local database, which does not only alleviate the pressure of data processing of the branch-office server and the central server, but also increases the efficiency of the human-face authentication.

The above-described device embodiments are merely illustrative, wherein the units that are described as separate components may or may not be physically separate, and the components that are displayed as units may or may not be physical units; in other words, they may be located at the same one location, and may also be distributed to a plurality of network units. Some or all of the modules may be selected according to the actual demands to realize the purposes of the solutions of the embodiments. A person skilled in the art may understand and implement the technical solutions without paying creative work.

Each component embodiment of the present disclosure may be implemented by hardware, or by software modules that are operated on one or more processors, or by a combination thereof. A person skilled in the art should understand that some or all of the functions of some or all of the components of the calculating and processing device according to the embodiments of the present disclosure may be implemented by using a microprocessor or a digital signal processor (DSP) in practice. The present disclosure may also be implemented as apparatus or device programs (for example, computer programs and computer program products) for implementing part of or the whole of the method described herein. Such programs for implementing the present disclosure may be stored in a non-transient computer-readable medium, or may be in the form of one or more signals. Such signals may be downloaded from an Internet web outlet, or provided on a carrier signal, or provided in any other forms.

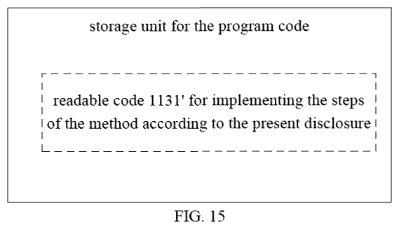

For example, FIG. 14 shows a calculating and processing device that may implement the method according to the present disclosure. The calculating and processing device traditionally includes a processor 1110 and a computer program product or non-transient computer-readable medium in the form of a memory 1120. The memory 1120 may be electronic memories such as flash memory, EEPROM (Electrically Erasable Programmable Read Only Memory), EPROM, hard disk or ROM. The memory 1120 has the storage space 1130 of the program code 1131 for implementing any steps of the above method. For example, the storage space 1130 for program code may contain program codes 1131 for individually implementing each of the steps of the above method. Those program codes may be read from one or more computer program products or be written into the one or more computer program products. Those computer program products include program code carriers such as a hard disk, a compact disk (CD), a memory card or a floppy disk. Such computer program products are usually portable or fixed storage units as shown in FIG. 15. The storage unit may have storage segments or storage spaces with similar arrangement to the memory 1120 of the calculating and processing device in FIG. 14. The program codes may, for example, be compressed in a suitable form. Generally, the storage unit contains a computer-readable code 1131′, which may be read by a processor like 1110. When those codes are executed by the calculating and processing device, the codes cause the calculating and processing device to implement each of the steps of the method described above.

It should be understood that, although the steps in the flow charts in the drawings are shown sequentially according to the indication by the arrows, those steps are not necessarily performed sequentially according to the sequence indicated by the arrows. Unless expressly described herein, the sequence of the performances of those steps are not strictly limited, and they may be performed in other sequences. Furthermore, at least some of the steps in the flow charts in the drawings may include a plurality of sub-steps or a plurality of stages, wherein those sub-steps or stages are not necessarily completely performed at the same one moment, but may be performed at different moments, and their performance sequence is not necessarily sequential performance, but may be performance alternate with at least some of the other steps or the sub-steps or stages of the other steps.

The “one embodiment”, “an embodiment” or “one or more embodiments” as used herein means that particular features, structures or characteristics described with reference to an embodiment are included in at least one embodiment of the present disclosure. Moreover, it should be noted that here an example using the wording “in an embodiment” does not necessarily refer to the same one embodiment.

The description provided herein describes many concrete details. However, it may be understood that the embodiments of the present disclosure may be implemented without those concrete details. In some of the embodiments, well-known processes, structures and techniques are not described in detail, so as not to affect the understanding of the description.

In the claims, any reference signs between parentheses should not be construed as limiting the claims. The word “include” does not exclude elements or steps that are not listed in the claims. The word “a” or “an” preceding an element does not exclude the existing of a plurality of such elements. The present disclosure may be implemented by means of hardware comprising several different elements and by means of a properly programmed computer. In unit claims that list several devices, some of those devices may be embodied by the same item of hardware. The words first, second, third and so on do not denote any order. Those words may be interpreted as names.

Finally, it should be noted that the above embodiments are merely intended to explain the technical solutions of the present disclosure, and not to limit them. Although the present disclosure is explained in detail with reference to the above embodiments, a person skilled in the art should understand that he may still modify the technical solutions set forth by the above embodiments, or make equivalent substitutions to part of the technical features of them. However, those modifications or substitutions do not make the essence of the corresponding technical solutions depart from the spirit and scope of the technical solutions of the embodiments of the present disclosure.

1. A database managing method, wherein the method is applied to a human-face-recognition platform, the human-face-recognition platform is connected to a central server of a head office, the central server is, via a branch-office server of a branch office subordinate to the head office, connected to outlet servers of outlets subordinate to the branch office, and the method comprises:
acquiring user data of a target user;
selecting a target outlet matching with the user data from the outlets; and
controlling the central server to dispatch a user feature of the target user to a target-outlet server of the target outlet via the branch-office server, to make the target-outlet server perform human-face recognition to the target user according to the user feature.

2. The method according to claim 1, wherein the user data comprise: a user permanent location; and
selecting the target outlet matching with the user data from the outlets comprises:
calculating location distances between outlet locations of the outlets and the user permanent location; and
using an outlet whose location distance satisfies a service-distance requirement as the target outlet.

3. The method according to claim 2, wherein using the outlet whose location distance satisfies the service-distance requirement as the target outlet comprises:
when the user permanent location comprises a residential location, using at least three outlets with lowest location distances from the residential location as the target outlet.

4. The method according to claim 2, wherein using the outlet whose location distance satisfies the service-distance requirement as the target outlet comprises:
when the user permanent location comprises a residential location and a activity location, using at least one outlet with a lowest location distance from the residential location and at least two outlets with lowest location distances from the activity location as the target outlet.

5. The method according to claim 2, wherein calculating the location distances between the outlet locations of the outlets and the user permanent location comprises:
calculating vector comparison values between the user permanent location and the outlet locations, wherein the outlet locations are vectors formed by a province, a city, a county, a town, a street and a community; and
using an outlet whose vector comparison value is greater than a comparison-value threshold as the target outlet.

6. The method according to claim 5, wherein using the outlet whose vector comparison value is greater than the comparison-value threshold as the target outlet comprises:
using outlets whose vector comparison values are greater than the comparison-value threshold as candidate outlets;
when a quantity of the candidate outlets is less than or equal to a quantity threshold, using the candidate outlets as the target outlet; and
when the quantity of the candidate outlets is greater than the quantity threshold, using a target quantity of the candidate outlets with lowest location distances from the user permanent location as the target outlet.

7. The method according to claim 1, wherein the user data comprise: a user service type; and
selecting the target outlet matching with the user data from the outlets comprises:
using an outlet whose scope of services comprises the user service type as the target outlet from the outlets.

8. A human-face-authentication method, wherein the method is applied to an outlet server of an outlet, the outlet server acquires a user feature by using the database managing method according to claim 1, and the method comprises:
receiving a human-face-authentication request carrying a human-face image;
when a user feature matching with the human-face image is not obtained by inquiring in a local outlet database, sending the human-face-authentication request to the branch-office server of the branch office; and
receiving a human-face-authentication result sent by the branch-office server according to the human-face-authentication request, and synchronizing the user feature from the branch-office server.

9. The method according to claim 8, wherein the method further comprises:
counting up usage frequency of the user feature according to a preset time period; and
deleting the user feature whose usage frequency is less than a frequency threshold from the local outlet database.

10. A human-face-authentication method, wherein the method is applied to a branch-office server of a branch office, the branch-office server acquires a user feature by using the database managing method according to claim 1, and the method comprises:
receiving a human-face-authentication request carrying a human-face image sent by an outlet server of an outlet;
when a user feature matching with the human-face image is not obtained by inquiring in a local branch-office database, sending the human-face-authentication request to the central server of the head office;
receiving a human-face-authentication result sent by the central server according to the human-face-authentication request, and forwarding the human-face-authentication result to the outlet server; and
synchronizing the user feature from the central server, and synchronizing the user feature to the outlet server.

11. The method according to claim 10, wherein the branch-office database comprises: a high-frequency database and a low-frequency database; and
before sending the human-face-authentication request to the branch-office server of the branch office when the user feature matching with the human-face image is not obtained by inquiring in the local outlet database, the method further comprises:
when the user feature matching with the human-face image is not obtained by inquiring in the high-frequency database, inquiring the user feature matching with the human-face image in the low-frequency database.

12. The method according to claim 11, wherein the method further comprises:
when a data volume of the low-frequency database is greater than a data volume of the high-frequency database, deleting the user feature with lowest usage frequency of a preset data-volume proportion in the low-frequency database with lowest usage frequency; and
when the data volume of the low-frequency database is less than the data volume of the high-frequency database, deleting the user feature in the low-frequency database with a usage frequency less than a usage-frequency threshold.

13. A calculating and processing device, wherein the calculating and processing device comprises:
a memory storing a computer-readable code; and
one or more processors, wherein when the computer-readable code is executed by the one or more processors, the calculating and processing device implements the database managing method according to claim 1.

14. A non-transient computer-readable medium, wherein the non-transient computer-readable medium stores the database managing method according to claim 1.

15. A calculating and processing device, wherein the calculating and processing device comprises:
a memory storing a computer-readable code; and
one or more processors, wherein when the computer-readable code is executed by the one or more processors, the calculating and processing device implements the human face authentication method according to claim 8.

16. A non-transient computer-readable medium, wherein the non-transient computer-readable medium stores the human face authentication method according to claim 8.
